(19) United States
(12) Patent Application Publication
(10) Pub. No.: US 2016/0159989 A1
(43) Pub. Date: Jun. 9, 2016

(54) ORGANIC/INORGANIC HYBRID COMPOUND FOR FOULING RESISTANCE, MEMBRANE FOR FOULING RESISTANCE, AND METHOD OF PREPARING FOULING RESISTANT MEMBRANE

(71) Applicant: SAMSUNG ELECTRONICS CO., LTD., Suwon-si, Gyeonggi-do (KR)

(72) Inventors: Hyo KANG, Seoul (KR); Sung Soo HAN, Hwaseong-si (KR)

(21) Appl. No.: 14/392,144

(22) PCT Filed: Jun. 25, 2014
(86) PCT No.: PCT/KR2014/005649

§ 371 Date: Dec. 23, 2015

(30) Foreign Application Priority Data
Jun. 25, 2013 (KR) 10-2013-0073343

(51) Int. Cl. C08G 83/00; A01N 55/00; B05D 1/00; A01N 25/34

(52) U.S. Cl. CPC C08G 83/001; A01N 25/34; A01N 55/00; B05D 1/005

(57) ABSTRACT

An organic/inorganic composite compound is disclosed, which includes a core of a polyhedron of polyhedral oligomeric silsesquioxane and at least one arm connected to a silicon atom of the polyhedral oligomeric silsesquioxane. The at least one arm includes a vinyl-based first structural unit including at least one ethylene oxide group at a side chain thereof and a vinyl-based second structural unit including at least one anti-biotic functional group at a side chain thereof.

### CROSS REFERENCE TO RELATED APPLICATIONS

This is a National Phase Application of PCT/KR2014/005649, filed Jun. 25, 2014, which is an International Application claiming priority to Korean Application No. 10-2013-0073343, filed Jun. 25, 2013, the entire contents of each of which are hereby incorporated by reference.

### TECHNICAL FIELD

Example embodiments are directed to an organic/inorganic fouling resistant composite compound, a fouling resistant membrane, and a method of preparing a fouling resistant membrane.

### BACKGROUND ART

Membrane fouling is one problem in the membrane industry. It is characterized by a decrease in the membrane permeation rate over time, which is generally induced by components in a feed solution passing through the membrane. It may be caused by molecule adsorption in the membrane pores, pore blocking, or cake formation on the membrane surface. A decrease in permeation rate increases operation energy use, and to overcome this, cleaning is required. However, this is only a temporary solution, and fouling typically decreases the life-span of the membrane.

As a method for reducing fouling of membranes for reverse osmotic pressure (RO), forward osmotic pressure (FO), ultrafiltration (UF), and microfiltration (MF), imparting a hydrophilic surface to the membrane is a fundamental solution that is capable of providing fouling resistance while increasing the life-span of the membrane. To increase fouling resistance of a membrane by graft polymerization of a hydrophilic group on the membrane surface, various hydrophilic monomers are grafted by various synthesis membranes to restrict fouling by microorganisms (e.g., bacteria and the like) and natural organic materials (e.g., proteins and the like). An important drawback of the surface modification method is the initiation of graft polymerization using high energy gamma radiation or plasma. This approach may increase membrane manufacturing costs, and it is not controlled well.

Another approach to provide a fouling resistant surface is by preparing a membrane including a micro-phase separated polyacrylonitrile amphiphilic graft copolymer (WO/2007/120631). A drawback of the surface modification method is a need to prepare new materials by synthesis and to establish a membrane preparing method. The approach, however, may allow long term stability to the resulting membrane, while minimizing deformation of the membrane.

Still another approach to provide a fouling resistant membrane is by adding a hydrophilic additive during preparation of the membrane. This approach does not require an additional process, while limiting cost, as well as allowing compatibility with conventional membrane preparation process. In order to provide uniform pore size, homologous polymers should be used, which has drawback of low stability due to weak chemical bonding among polymers, in which a hydrophilic polymeric additive may leak.
The easiest method of preparing fouling resistant membrane is by coating hydrophilic material on the surface of a membrane. This approach may be the most close to commercialize. An example of this approach is the membrane on which polydopamine, a representative material of bio-inspired polymers (US2010/0059433).

### DISCLOSURE

### Technical Problem

An example embodiment is directed to an organic/inorganic fouling resistant composite compound, which may be used to prepare a membrane.

Another example embodiment is directed to a fouling resistant membrane manufacture by using an organic/inorganic fouling resistant composite compound.

Another example embodiment is directed to a method of preparing a fouling resistant membrane by using organic/inorganic fouling resistant composite compound.

### Technical Solution

According to an example embodiment, provided is an organic/inorganic composite compound including a core of a polyhedron of a polyhedral oligomeric silsesquioxane, and at least one arm connected to a silicon (Si) atom of the polyhedral oligomeric silsesquioxane, wherein the at least one arm includes a vinyl-based first structural unit and a vinyl-based second structural unit. The vinyl-based first structural unit includes at least one ethylene oxide group at a side chain of the vinyl-based first structural unit. The vinyl-based second structural unit includes at least one anti-biotic group at the side chain.

An atomic ratio of silicon (Si) to oxygen (O) in the polyhedron of the polyhedral oligomeric silsesquioxane may be about 1:1 to 3/2.

The polyhedron of the polyhedral oligomeric silsesquioxane may be one selected from a pentahedron of the following Chemical Formula 1, a hexahedron of the following Chemical Formula 2, a heptahedron of the following Chemical Formula 3, an octahedron of the following Chemical Formula 4, an enneahedron of the following Chemical Formula 5, a decahedron of the following Chemical Formula 6 and derivatives thereof.

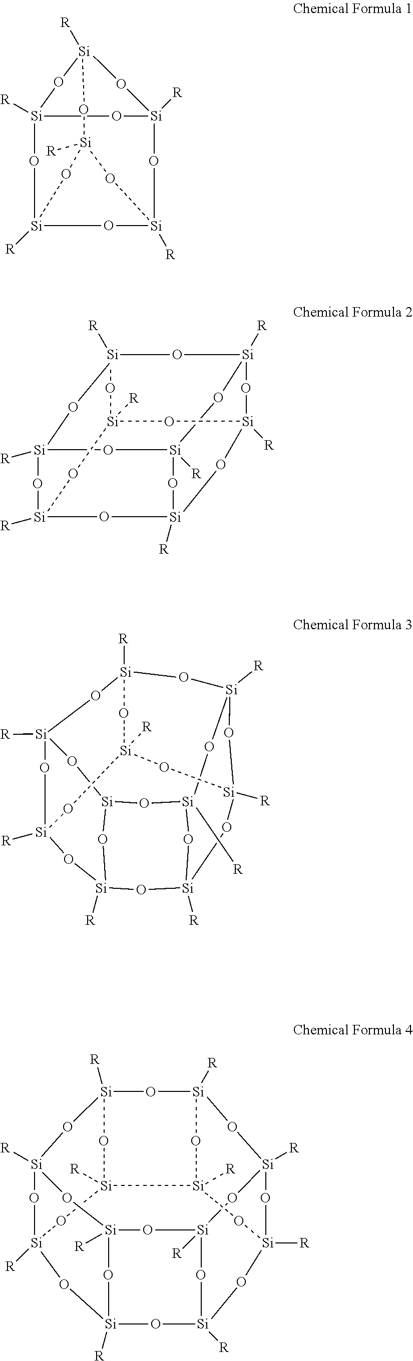

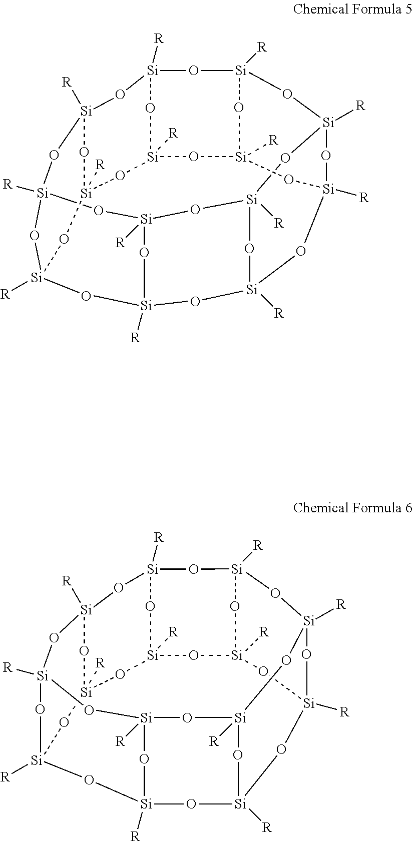

In Chemical Formulas 1 to 6, groups represented by R's are the same or different, and are each independently one selected from hydrogen, a hydroxy group, a nitro group, a cyano group, an imino group (═NH, ═NR¹⁰¹, wherein R¹⁰¹ is a C1 to C10 alkyl group), an amino group (—NH₂, —NH(R¹⁰²), and —N(R¹⁰³)(R¹⁰⁴), wherein R¹⁰² to R¹⁰⁴ are each independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, a C2 to C30 heteroaryl group, a C1 to C30 alkoxy group, a C1 to C30 fluoroalkyl group, and an *L¹-A group (wherein L¹ is a linking group and A is the arm), provided that at least one group represented by R is an *L¹-A group.

The polyhedron may include a closed polyhedron having oxygen (O) in at least one —Si—O—Si— bond unsubstituted and connected in the closed polyhedron.

The polyhedron may include an open polyhedron having O in at least one —Si—O—Si—bond of Chemical Formulas 1 to 6 substituted with substituents and disconnected in the polyhedron.

The L1 is one selected from a single bond, —O—, —OOC—, —COO—, —OCOO—, —NX— (wherein X is hydrogen or a C1-C10 alkyl group), —CO—, —SO2-, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 an alkylarylene group, a substituted or unsubstituted C2-C30 arylalkylene group, a substituted or unsubstituted silylene, a substituted or unsubstituted C2-C30 alkenyl group, a substituted or unsubstituted C2-C30 alkynyl group, and a group where at least one group of the foregoing groups is linked together.

The organic/inorganic composite compound may include an arm connected to 1 (one) to 16 (sixteen) Si atom of the polyhedral oligomeric silsesquioxane represented by any one of above Chemical Formulae 1 to 6.

The vinyl-based first structural unit including a side chain with at least one ethylene oxide group may be a structural unit represented by the following Chemical Formula 7.

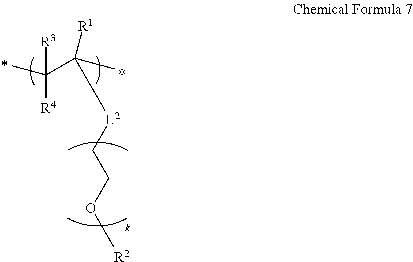

In the above Chemical Formula 7, L² is one selected from a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 an alkylarylene group, a substituted or unsubstituted C2-C30 arylalkylene group, and a group where at least one group of the foregoing groups is linked together. R¹, R², R³, and R⁴ are each independently one selected from hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, and a substituted or unsubstituted C2-C30 arylalkyl group. k is an integer ranging from 1 to 500.

The average k value of Chemical Formula 7 in the at least one arm may be about 5 to about 100.

In the vinyl-based second structural unit including a side chain with at least one anti-biotic group may be a structural unit represented by the following Chemical Formula 9:

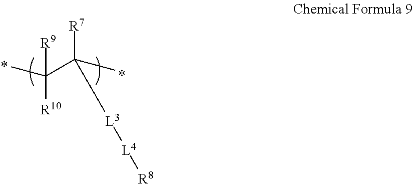

In the above Chemical Formula 9, R⁷, R⁹, and R¹⁰ are each independently one selected from hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, and a substituted or unsubstituted C2-C30 arylalkyl group. L³ is one selected from a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, and a group where at least one group of the foregoing groups is linked together. L⁴ is one selected from a single bond, —O—, —OOC—, —COO—, —OCOO—, —NHCO—, —CONH—, —CO—, —SO₂—, a substituted or unsubstituted C1-C30 alkylene group, a substituted or unsubstituted C2-C30 alkenylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, and a group where at least one group of the foregoing groups is linked together. R⁸ is a group represented by the following Chemical Formula 10.

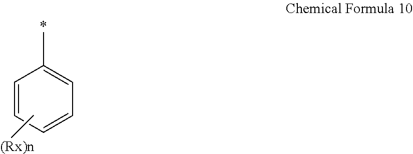

In the above Chemical Formula 10, Rx is the same or different in each repeating unit, and independently one selected from hydrogen, a hydroxy group, a nitro group, a cyano group, an imino group (═NH, ═NR¹⁰¹, R¹⁰¹ is a C1 to C10 alkyl group), an amino group (—NH₂, —NH(R¹⁰²), and —N(R¹⁰³)(R¹⁰⁴), wherein R¹⁰² to R¹⁰⁴ are independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, a C2 to C30 heteroaryl group, C1 to C30 alkoxy group, a C1 to C30 fluoroalkyl group, a C5 to C30 alkenyl group including at least one double bond, or a C5 to C30 alkynyl group including at least one triple bond. In the above Chemical Formula 10, n may be an integer of 1 to 5. In the above Chemical Formula 10, at least about 30 mol % to about 100 mol % of Rx may be C5 to C30 alkyl group, C5 to C30 alkenyl group including at least one double bond, or C5 to C30 alkynyl group including at least one triple bond, provided that at least about 5 mol % to 100 mol % of which may be C5 to C30 alkenyl group including at least one double bond, or C5 to C30 alkynyl group including at least one triple bond.

The molar ratio of first structural unit and the second structural unit in the at least one arm may range from about 95 mol %:about 5 mol % to about 60 mol %:about 40 mol %. For example, the molar ratio of first structural unit and the second structural unit in the at least one arm may range from about 92 mol %:about 8 mol % to about 65 mol %:about 35 mol %.

According to another example embodiment, a fouling resistant membrane is provided that includes a surface layer including the organic/inorganic fouling resistant composite compound.

The surface layer may have a contact angle of about 10 to about 90 degrees. The surface layer has a thickness of about 0.01 μm to about 100 μm.

The fouling resistance membrane may further include an inner layer under the surface layer. The inner layer may include at least one compound selected from a polyacrylate-based compound, a polymethacrylate-based compound, a polystyrene-based compound, a polycarbonate-based compound, a polyethylene terephthalate-based compound, a polyimide-based compound, a polybenzimidazole-based compound, a polybenzthiazole-based compound, a polybenzoxazole-based compound, a polyepoxy resin compound, a polyolefin-based compound, a polyphenylene vinylene compound, a polyamide-based compound, a polyacrylonitrile-based compound, a polysulfone-based compound, a cellulose-based compound, polyvinylidene fluoride (PVDF), polytetrafluoroethylene (PTFE), a polyvinylchloride (PVC) compound, and a combination thereof.

According to an example embodiment, provided is a water treatment membrane including the fouling resistant membrane. The fouling resistant membrane may include an inner layer and the surface layer, wherein the inner layer may be one selected from a microfiltration membrane, an ultrafiltration membrane, a nanofiltration membrane, a reverse osmotic membrane, and a forward osmotic membrane.

The inner layer may be a single membrane formed of a homogeneous material, or a composite membrane including a plurality of layers formed of a heterogeneous material.

According to yet another example embodiment, a method of preparing a fouling resistant membrane is provided that includes preparing a solution including the organic/inorganic fouling resistant composite compound and a solvent, and forming a surface layer by coating a solution on a surface of a preliminary membrane.

The surface layer may be formed by coating the solution on the surface of the preliminary membrane by one selected from solvent casting, spin casting, wet spinning, dry spinning, melt processing, and melt spinning.

The solution may include about 0.1 to about 50 wt % of the organic/inorganic fouling resistance composite compound.

### Advantageous Effects

The membrane manufactured from using the organic/inorganic composite compound according to the embodiments exhibits good fouling resistance performance, which leads to the extended life-span of the membrane. Further, the cost for maintaining and cleaning the membrane may be reduced. The membrane may also be used to treat water for drinking, as its anti-bio fouling resistance is great.

### DESCRIPTION OF DRAWINGS

Example embodiments will be more clearly understood from the following detailed description taken in conjunction with the accompanying drawings. FIGS. 1-10 represent non-limiting, example embodiments as described herein.

FIG. 1 is a schematic view showing the shape of an organic/inorganic composite compound for fouling resistance according to example embodiments,

FIG. 2 is a schematic view of a membrane with fouling resistance including a surface layer and an inner layer according to example embodiments;

FIG. 3 is a graph determined by an X-ray Photoelectron Spectroscopy of the compounds SPC13, SPC24, SPC 45, synthesized in Example 1, Example 2, and Comparative Example 2, respectively, and of commercialized polysulfone (PS) membrane;

FIG. 4 shows scanning electron microscope photographs of the surface layers of commercialized polysulfone (a), and of the membranes manufactured by curing those prepared in Example 1(b), Example 2(c), and Comparative Example 1(d), respectively;

FIG. 5 shows captive buble water contact angle changes of the membranes manufactured by coating the compounds synthesized in Example 1, and Example 2, followed by curing, and of commercialized polysulfone.

FIG. 6 shows captive buble decan contact angle changes of the membranes manufactured by coating the compounds synthesized in Example 1, and Example 2, followed by curing, and of commercialized polysulfone.

FIG. 7 shows anti-biofouling properties of the membranes manufactured by coating the compounds synthesized in Example 1, Example 2, and Comparative Example 1, followed by curing, and of commercialized polysulfone.

FIG. 8 shows anti-oil fouling properties of the membranes manufactured by coating the compounds synthesized in Example 1, Example 2, and Comparative Example 1, followed by curing, and of commercialized polysulfone.

FIG. 9 shows anti-bio fouling effects of the compounds prepared in Comparative Example 1(SPC0), Example 1(SPC13), Example 2(SPC24), and Comparative Example 2(SPC45), by culturing bacteria for 24 hours by spreading on agar plates, after culturing them on a silicon wafer with no treatment, or on a plate treated with the compounds, respectively.

FIG. 10 shows the change of bacteria colony depending on time, when culturing the bacteria in medium containing the compounds, Example 1 (SPC13), Example 2 (SPC24), Comparative Example 1(SPC0), and Comparative Example 2(SPC45), respectively.

### BEST MODE

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the invention.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof. Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly. Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, the present invention is not limited to example embodiments described.

As used herein, when a definition is not otherwise provided, the term “substituted” may refer to one substituted with a halogen (F, Cl, Br, or I); a hydroxy group; a nitro group; a cyano group; an imino group (═NH or ═NR¹⁰¹ wherein R¹⁰¹ is a C1 to C10 alkyl group); an amino group (—NH2, —NH(R¹⁰²), and —N(R¹⁰³)(R¹⁰⁴), wherein R¹⁰² to R¹⁰⁴ are each independently a C1 to C10 alkyl group); an amidino group; a hydrazine group; a hydrazone group; a carboxyl group; a C1 to C30 alkyl group; a C1 to C30 alkylsilyl group; a C3 to C30 cycloalkyl group; a C2 to C30 heterocycloalkyl group; a C6 to C30 aryl group; a C2 to C30 heteroaryl group; a C1 to C30 alkoxy group; or a C1 to C30 fluoroalkyl group.

As used herein, when a definition is not otherwise provided, the prefix “hetero” may refer to one including 1 to 3 heteroatoms selected from N, O, S, and P, and remaining carbons in a compound or a substituent.

As used herein, when a definition is not otherwise provided, the term “combination thereof” refers to at least two substituents bound to each other by a linker, or at least two substituents condensed to each other.

As used herein, when a definition is not otherwise provided, the term “alkyl group” may refer to a “saturated alkyl group” without an alkenyl group or an alkynyl group, or an “unsaturated alkyl group” including at least one of an alkenyl group and an alkynyl group. The term “alkenyl group” may refer to a substituent in which at least two carbon atoms are bound in at least one carbon-carbon double bond, and the term “alkynyl group” refers to a substituent in which at least two carbon atoms are bound in at least one carbon-carbon triple bond. The alkyl group may be a branched, linear, or cyclic alkyl group.

The alkyl group may be a C1 to C20 alkyl group, and more specifically a C1 to C6 alkyl group, a C7 to C10 alkyl group, or a C11 to C20 alkyl group.

For example, a C1-C4 alkyl may have 1 to 4 carbon atoms, and may be selected from methyl, ethyl, propyl, iso-propyl, n-butyl, iso-butyl, sec-butyl, and t-butyl.

Examples of the alkyl group include a methyl group, an ethyl group, a propyl group, an isopropyl group, a butyl group, an isobutyl group, a t-butyl group, a pentyl group, a hexyl group, an ethenyl group, a propenyl group, a butenyl group, a cyclopropyl group, a cyclobutyl group, a cyclopentyl group, a cyclohexyl group, and the like.

The term “aromatic group” may refer a substituent including a cyclic structure where all elements have p-orbitals that form conjugation. An aryl group and a heteroaryl group may be exemplified.

The term “aryl group” may refer to a monocyclic or fused ring-containing polycyclic (i.e., rings sharing adjacent pairs of carbon atoms) groups.

The “heteroaryl group” may refer to one including 1 to 3 heteroatoms selected from N, O, S, or P in an aryl group, and remaining carbons. When the heteroaryl group is a fused ring, each ring may include 1 to 3 heteroatoms.

As used herein, the symbol “*” refers to a point connected to another atom or chemical formula.

Example embodiments are directed to an organic/inorganic fouling resistant composite compound, a fouling resistant membrane, and a method of preparing a fouling resistant membrane.

The organic/inorganic composite compound for fouling resistance according to example embodiments includes a core and an arm, wherein the core is formed of a polyhedron of polyhedral oligomeric silsesquioxane. The organic/inorganic composite compound for fouling resistance includes at least one arm connected to a Si atom of the polyhedral oligomeric silsesquioxane.

The number of arms of the organic/inorganic composite compound for fouling resistance is not particularly limited but may be at most a quantity that correlates to the number of Si atoms included in the polyhedral oligomeric silsesquioxane. When 3 or more arms are included, the organic/inorganic composite compound may form a star shape.

The atomic ratio of Si to O in the polyhedron of the polyhedral oligomeric silsesquioxane may be about 1:1 to 3/2. When the atomic ratio of Si:O is 1:3/2, all of the Si atoms are connected to three adjacent Si atoms with an O atom therebetween, so as to form an —Si—O—Si—bond, thus forming a polyhedron of a closed structure. The polyhedral oligomeric silsesquioxane may include a polyhedron of an open structure wherein a part of the —Si—O—Si—bond is disconnected, as well as a polyhedron of a closed structure having the atomic ratio of Si:O of 1:3/2. For example, the polyhedron of an open structure may be formed when O in at least one —Si—O—Si—bond of the polyhedral oligomeric silsesquioxane is substituted by substituents thus breaking the —Si—O—Si—bond. The substituent may be as explained above without specific limitations. However, if substituents having a relatively strong hydrophobic characteristic are introduced, it may be difficult to impart hydrophilicity to a desired degree to the organic/inorganic composite compound for fouling resistance. Thus, if one were seeking to provide an organic/inorganic composite compound for fouling resistance by performing a method that improves hydrophilicity (e.g., a membrane for water treatment), hydrophilic substituents may be included on the organic/inorganic composite compound to improve permeability performance of the membrane.

Specific examples of the polyhedral oligomeric silsesquioxane may be a pentahedron of the following Chemical Formula 1, a hexahedron of the following Chemical Formula 2, a heptahedron of the following Chemical Formula 3, an octahedron of the following Chemical Formula 4, an enneahedron of the following Chemical Formula 5, and a decahedron of the following Chemical Formula 6.

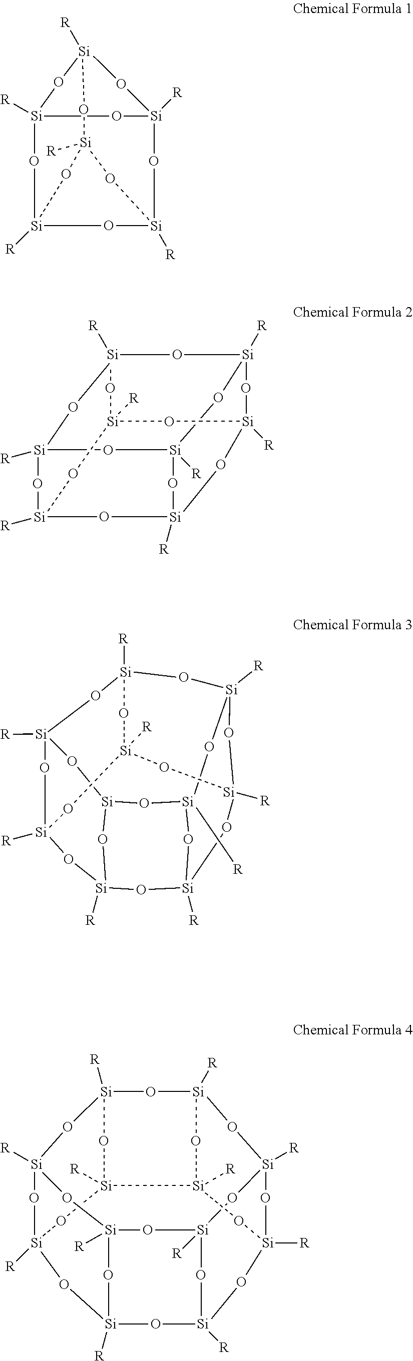

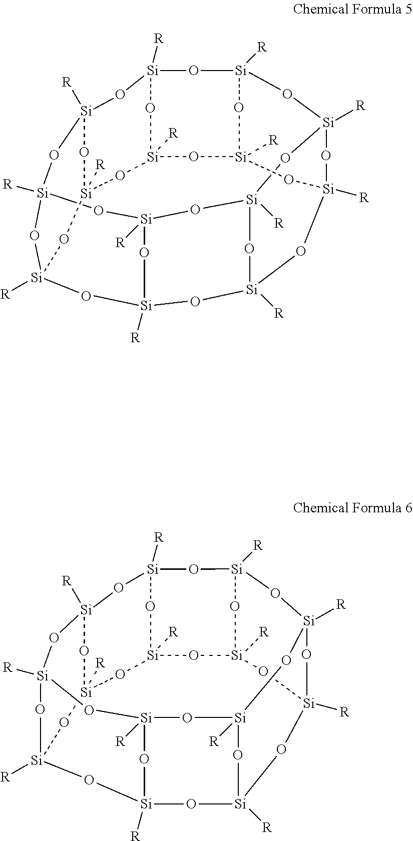

In Chemical Formulas 1 to 6, groups represented by R's are the same or different, and are each independently, hydrogen, a hydroxy group, a nitro group, a cyano group, an imino group (═NH, ═NR¹⁰¹ wherein R¹⁰¹ is a C1 to C10 alkyl group), an amino group (—NH₂, —NH(R¹⁰²), and —N(R¹⁰³)(R¹⁰⁴), wherein R¹⁰² to R¹⁰⁴ are independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, a C2 to C30 heteroaryl group, a C1 to C30 alkoxy group, a C1 to C30 fluoroalkyl group, or an *-L¹-A group (wherein L¹ is a linking group and A is the arm), provided that at least one group represented by R is an *-L¹-A group.

The L¹ is a linking group of the core and arm (A). The L¹ may be, for example, a single bond, —O—, —OOC—, —COO—, —OCOO—, —NX— (X is hydrogen or a C1-C10 alkyl group), —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 an alkylarylene group, a substituted or unsubstituted C2-C30 arylalkylene group, a substituted or unsubstituted silylene group, a substituted or unsubstituted C2-C30 alkenyl group, a substituted or unsubstituted C2-C30 alkynyl group, or a group where at least one group of the foregoing groups is linked together.

In case the polyhedral oligomeric silsesquioxane of the above Chemical Formulas 1 to 6 has the maximum number of arms, all groups represented by R are respectively the *-L1-A group. For example, Chemical Formula 1 may have a maximum of 6 arms, Chemical Formula 2 may have a maximum of 8 arms, Chemical Formula 3 may have a maximum 10 of arms, Chemical Formula 4 may have a maximum of 12 arms, Chemical Formula 5 may have a maximum of 14 arms, and Chemical Formula 6 may have a maximum of 16 arms.

The arm connected to at least one Si atom of the polyhedral oligomeric silsesquioxane may include a vinyl-based first structural unit including at least one ethylene oxide group at the side chain, and a vinyl-based second structural unit including at least one anti-biotic group at the side chain.

The arm may be formed by copolymerization of the first structural unit and the second structural unit, in the form of, for example, a block copolymer, an alternating copolymer, a random copolymer, a graft copolymer, and the like.

The first structural unit may be represented by the following Chemical Formula 7.

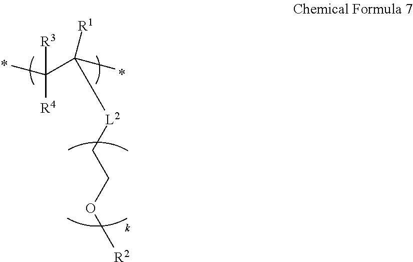

In the above Chemical Formula 7, L² is a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 an alkylarylene group, a substituted or unsubstituted C2-C30 arylalkylene group, or a group where at least one group of the foregoing groups is linked together. R¹, R², R³, and R⁴ are independently hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, or a substituted or unsubstituted C2-C30 arylalkyl group. K is an integer ranging from 1 to 500 (e.g., 3 to 250, or 5 to 100).

The vinyl-based first structural unit including the side chain with at least one ethylene oxide group may be, for example, an acrylate-based structural unit as follows.

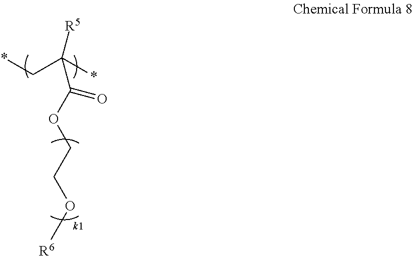

In the above Chemical Formula 8, R⁵ and R⁶ are each independently hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, or a substituted or unsubstituted C2-C30 arylalkyl group, and k1 is an integer ranging from 1 to 500 (e.g., 3 to 250, or 5 to 100).

The first structural unit may include an ethylene oxide group at the side chain. The number of ethylene oxide groups may be increased to extend in a side chain direction of the arm, such that the organic/inorganic composite compound for fouling resistance may become a comb-shaped hydrophilic polymer. For example, even if the same amount of oxygen is included when forming a membrane, the ethylene oxide group is more exposed on the surface of a comb-shaped polymer. Thus, oxygen content on the surface of the comb-shaped polymer may be increased. When the oxygen content on the surface increases, the possibility of forming a hydration surface or a hydration barrier may increase.

One arm in the organic/inorganic composite compound for fouling resistance may include a plurality of the first structural units having different k values, and one arm may have an average k value of about 5 to about 100. For example, when the average k value is about 5 to about 100, the hydrophilicity and fouling resistance of the organic/inorganic composite compound for fouling resistance, and the polymerization degree of the arm, may be suitable for use in a membrane, for example, for water treatment.

The ethylene oxide group imparts hydrophilicity and fouling resistance to the organic/inorganic composite compound for fouling resistance. Because the ethylene oxide group may inhibit adsorption of, for example, a protein (and/or the like), it has an excellent anti-bio-fouling effect.

When the organic/inorganic composite compound for fouling resistance has arms connected in a star shape, the surface content of the ethylene oxide group may be further increased to further increase the fouling resistance effect. For example, the organic/inorganic composite compound for fouling resistance may have 1 to 16 arms. The organic/inorganic composite compound for fouling resistance having the above number range of the arms may properly manifest the fouling resistance effect for bio-fouling.

The second structural unit may be represented by the following Chemical Formula 9.

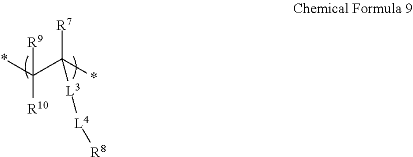

In the above Chemical Formula 9, R⁷, R⁹, and R¹⁰ are each independently hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, or a substituted or unsubstituted C2-C30 arylalkyl group. L³ is a single bond, —O—, —OOC—, —COO—, —OCOO—, —NHCO—, —CONH—, —CO—, —SO₂—, a substituted or unsubstituted C1-C30 alkylene group, a substituted or unsubstituted C2-C30 alkenylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, or a group where at least one group of the foregoing groups is linked together. L⁴ is a linking group for linking the oleophobic functional group, R⁸. L⁴ is a single bond, —O—, —OOC—, —COO—, —OCOO—, —NHCO—, —CONH—, —CO—, —SO₂—, a substituted or unsubstituted C1-C30 alkylene group, a substituted or unsubstituted C2-C30 alkenylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, or a group where at least one group of the foregoing groups is linked together.

R⁸ may be one of groups represented by the following Chemical Formulas 10.

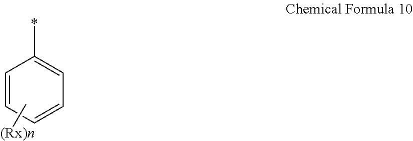

In the above Chemical Formula 10, Rx may be the same or different, and is independently hydrogen, a hydroxy group, a nitro group, a cyano group, an imino group (═NH, ═NR¹⁰¹, wherein R¹⁰¹ is a C1 to C10 alkyl group), an amino group (—NH₂, —NH(R¹⁰²), —N(R¹⁰³)(R¹⁰⁴), wherein R¹⁰² to R¹⁰⁴ are independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, C2 to C30 heteroaryl group, C1 to C30 alkoxy group, a C1 to C30 fluoroalkyl group, C5 to C30 alkenyl group including at least one double bond, or C5 to C30 alkynyl group including at least one triple bond. In the above Chemical Formula 10, n may be an integer ranging of 1 to 5. In the above Chemical Formula 10, at least about 30 mol % to about 100 mol % of Rx may be C5 to C30 alkyl group, C5 to C30 alkenyl group including at least one double bond, or C5 to C30 alkynyl group including at least one triple bond, provided that at least about 5 mol % to 100 mol % of which may be C5 to C30 alkenyl group including at least one double bond, or C5 to C30 alkynyl group including at least one triple bond.

As will be described in the Examples, if the second structural unit includes Rx, which is C5 to C30 alkyl group, C5 to C30 alkenyl group including at least one double bond, or C5 to C30 alkynyl group including at least one triple bond, at the above amount, the organic/inorganic composite compound may impart excellent anti-bio-fouling characteristics.

Further, if the second structural unit includes Rx, which is C5 to C30 alkenyl group including at least one double bond, or C5 to C30 alkynyl group including at least one triple bond, at the above amount, the organic/inorganic composite compound may become insoluble after curing.

Without being bound to a specific theory, the functional group represented by the above Chemical Formula 10 of the second structural unit imparts blocking effects, as well as sterilizing effect, to microorganisms, e.g., bacteria, by including the group, Rx. Accordingly, the organic/inorganic composite compound including the first structural unit and the second structural unit has excellent effect of reducing fouling effects, such as protein-fouling or oil-fouling, as well as excellent antibiotic effect due to the reduced bio-fouling effect.

The vinyl-based second structural unit including a side chain with an anti-biotic functional group may derive from, for example, aromatic monoalkenyl monomer, alkyl ester monomer, unsaturated nitrile-based monomer, etc., and includes at least one anti-biotic functional group. For example, the vinyl-based second structural unit may derive from styrene based, alpha olefin based, acrylate based, methacrylate based, acrylonitrile based, allyl based, etc. For example, the vinyl-based second structural unit derive from styrene, p-methyl styrene, m-methyl styrene, o-methyl styrene, 2,4-dimethyl styrene, 2,5-dimethyl styrene, 3,4-dimethyl styrene, 3,5-dimethyl styrene, p-t-butyl styrene, methyl (meth)acrylate, butyl (meth)acrylate, methyl acrylate, ethyl acrylate, butyl acrylate, 2-ethyl hexyl acrylate, decylacrylate, acrylonitrile, methacrylonitrile, ethacrylonitrile, etc.

For example, the second structural unit including a side chain with a anti-biotic functional group may include a structural unit represented by the following Chemical Formula 11:

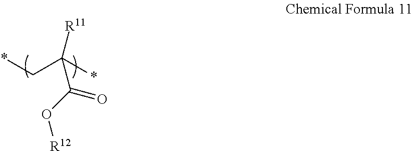

In Chemical Formula 11, R¹¹ may be a hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, or a substituted or unsubstituted C2-C30 arylalkyl group.

In above Chemical Formula 11, R¹² may be a structure formed by linking together L⁴ and R⁸ defined in the above Chemical Formula 9.

In one example, in above Chemical Formula 11, R¹¹ may be a hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, or a substituted or unsubstituted C2-C30 arylalkyl group, and R12 may be a group represented by the following Chemical Formula 12:

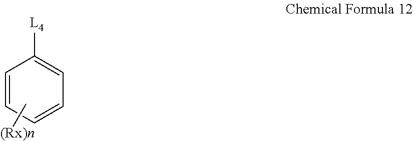

In Chemical Formula 12, L⁴ is a single bond, —O—, —NH—, —OCO—, —COO—, —OCOO—, —NHCO—, —CONH—, —CO—, —SO₂—, a substituted or unsubstituted C1-C30 alkylene group, a substituted or unsubstituted C2-C30 alkenylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, or a group where at least one group of the foregoing groups is linked together.

In above Chemical Formula 12, Rx may be the same or different in each repeating unit, and independently a hydrogen, a hydroxy group, a nitro group, a cyano group, an imino group (═NH, ═NR¹⁰¹, wherein R¹⁰¹ is a C1 to C10 alkyl group), an amino group (—NH₂, —NH(R¹⁰²), —N(R¹⁰³)(R¹⁰⁴), wherein R¹⁰² to R¹⁰⁴ are independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, C2 to C30 heteroaryl group, C1 to C30 alkoxy group, a C1 to C30 fluoroalkyl group, C5 to C30 alkenyl group including at least one double bond, or C5 to C30 alkynyl group including at least one triple bond. In the above Chemical Formula 12, n may be an integer ranging of 1 to 5. In the above Chemical Formula 12, at least about 30 mol % to about 100 mol % of Rx may be C5 to C30 alkyl group, C5 to C30 alkenyl group including at least one double bond, or C5 to C30 alkynyl group including at least one triple bond, provided that at least about 5 mol % to 100 mol % of which may be C5 to C30 alkenyl group including at least one double bond, or C5 to C30 alkynyl group including at least one triple bond, each based on the total mole number of the repeating unit represented by Chemical Formula 11.

The molar ratio of the first structural unit and the second structural unit in one arm may range from about 95 mol %:about 5 mol % to about 60 mol %:about 40 mol % (e.g., about 92 mol %:about 8 mol % to about 65 mol %:about 35 mol %). For example, the first structural unit may be included at amount about 90 mol %, about 87 mol %, about 85 mol %, about 80 mol %, about 77 mol %, about 75 mol %, about 70 mol %, about 67 mol %, about 65 mol %, or about 60 mol %.

When the first structural unit and the second structural unit are included in the above ratio, the organic/inorganic composite compound for fouling resistance may have characteristics of a water-insoluble property, and excellent fouling resistance (i.e., anti-bio-fouling and oil fouling inhibition), as well as hydrophilicity, making the organic/inorganic composite compound suitable for use as a membrane in a water treatment, while having solubility for a desired solvent for the preparation of a membrane for water treatment.

For example, the organic/inorganic composite compound for fouling resistance may be water-insoluble, while it may be dissolved in at least one organic solvent of acetone, acids (e.g., acetic acid, trifluoroacetic acid (TFA), and the like), alcohols (e.g., methanol, isopropanol, 1-methoxy-2-propanol, ethanol, terpineol, and the like), oxygen-containing cyclic compounds (e.g., tetrahydrofuran (THF), 1,4-dioxane, and the like), aromatic compounds including a heteroatom of N, O, or S (e.g., pyridine and the like), halogen compounds (e.g., chloroform, methylene chloride, and the like), aprotic polar compounds (e.g., dimethyl formamide (DMF), dimethyl acetamide (DMAC), dimethyl sulfoxide (DMSO), N-methyl-2-pyrrolidone (NMP), and the like), and acetates (e.g., 2-butoxyethylacetate, 2-(2-butoxyethoxy)ethylacetate, and the like).

The organic/inorganic composite compound for fouling resistance should be water-insoluble in order to be used for a membrane for water treatment, and it should be soluble in desired organic solvents in order to manufacture a membrane. These characteristics may be provided by controlling the structure of the arms including the first structural unit and the second structural unit as explained above. Accordingly, the organic/inorganic composite compound may be water-soluble before curing, but may become water-insoluble upon curing, after being coated on a surface of a membrane, by controlling structure of arms by controlling the ratio of the first structural unit and the second structural unit.

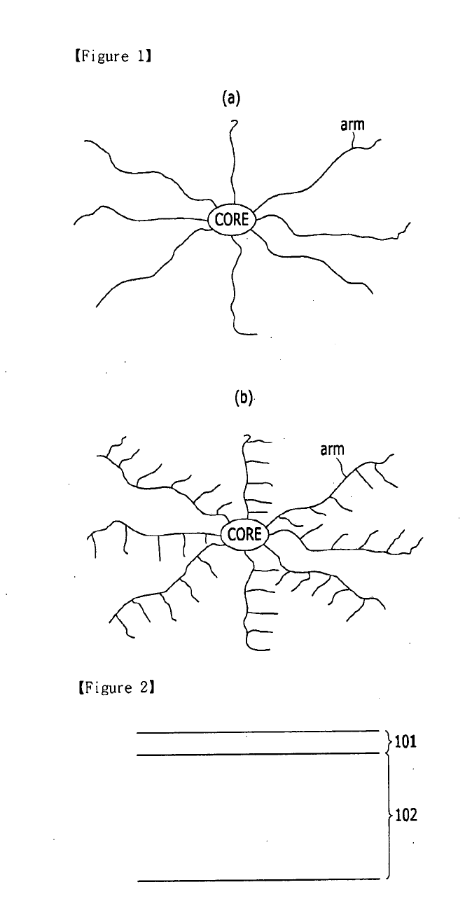

FIG. 1 (a) is a schematic view of one example wherein the organic/inorganic composite compound for fouling resistance has a star shape, and FIG. 1 (b) is a schematic view of one example wherein the ethylene oxide groups included in the side chain of the first structural unit and the anti-biotic group included in the side chain of the second structural unit in the arms are formed in a comb shape.

The organic/inorganic composite compound for fouling resistance has a core formed of a polyhedron of polyhedral oligomeric silsesquioxane, but is not limited thereto. The core may be in the form of an inorganic oxide, and the arm may be connected through a linking group. The inorganic oxide may include, for example, silica, titania, alumina, zirconia, yttria, chromium oxide, zinc oxide, iron oxide, clay, zeolite, and the like, but is not limited thereto.

A membrane with fouling resistance according to example embodiments includes a surface layer including the organic/inorganic composite compound for fouling resistance.

The membrane with fouling resistance is imparted with the fouling resistance characteristic by forming a surface layer including the organic/inorganic composite compound for fouling resistance on a membrane requiring the fouling resistance characteristic. The membrane with fouling resistance has an excellent effect of preventing the formation of biofilm and oil film, and thus it achieves the desired fouling resistance performance and excellent sterilizing effect, thereby extending the life-span of the membrane, decreasing the number of washings, and reducing operation energy consumption.

The shape and the kind of the membrane are not limited, and any membrane formed by a known method using a known material may be used. Such a membrane may be used as an inner layer, and a surface layer including the organic/inorganic composite compound for fouling resistance may be formed on the surface to manufacture the membrane with fouling resistance.

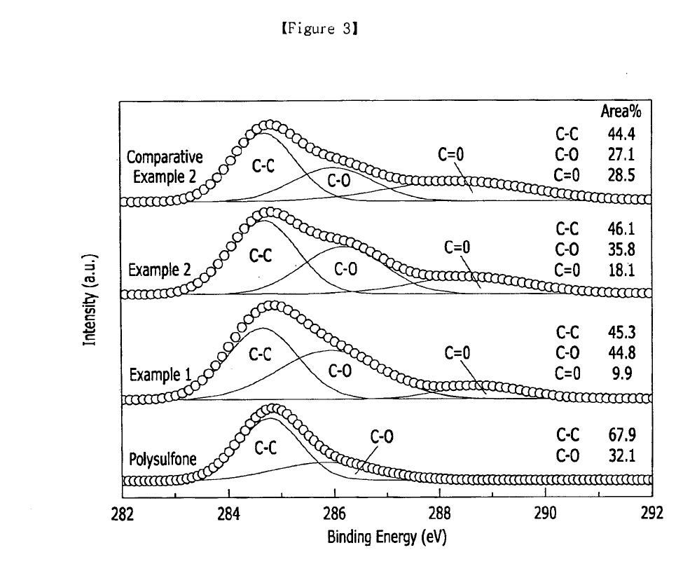

FIG. 2 is a schematic view of a membrane with fouling resistance including a surface layer and an inner layer according to example embodiments.

Referring to FIG. 2, a membrane 100 includes a surface layer 101 on a surface of an inner layer 102. The surface layer 101 may have a thickness of about 0.01 μm to about 100 μm (e.g., about 0.02 μm to about 50 μm). When the surface layer 101 has a thickness of about 0.01 μm to about 100 μm, fouling resistance and sterilization effect may be properly implemented.

The inner layer 102 may include, for example, at least one compound selected from a polyacrylate-based compound, a polymethacrylate-based compound, a polystyrene-based compound, a polycarbonate-based compound, a polyethylene terephthalate-based compound, a polyimide-based compound, a polybenzimidazole-based compound, a polybenzthiazole-based compound, a polybenzoxazole-based compound, a polyepoxy resin compound, a polyolefin-based compound, a polyphenylene vinylene compound, a polyamide-based compound, a polyacrylonitrile-based compound, a polysulfone-based compound, a cellulose-based compound, polyvinylidene fluoride (PVDF), polytetrafluoroethylene (PTFE), a polyvinyl chloride (PVC) compound and combinations thereof.

The surface layer 101 may be formed by any known method, and the method is not specifically limited. For example, a process such as solvent casting, spin casting, wet spinning, dry spinning, and the like may be used, and melt processing such as injection, melt spinning, and the like may be applied. Specifically, in the case of solvent casting, a solution including the organic/inorganic composite compound for fouling resistance dissolved in a solvent is prepared, coated on the surface of a preliminary membrane that will become the inner layer 102, and then dried to manufacture a membrane with fouling resistance. The concentration of the solution may be about 0.1 to about 50 wt %.

The surface layer 101 formed by the above method may be a continuous coating layer, or a discontinuous coating layer.

Specifically, the membrane with fouling resistance may be a membrane for water treatment (e.g., a separation membrane for water treatment). The separation membrane for water treatment may be a microfiltration membrane, an ultrafiltration membrane, a nanofiltration membrane, a reverse osmotic membrane, or a forward osmotic membrane according to use, and it may be divided (or configured) according to the size of particles to be separated. A method of preparing the separation membrane is not limited, and the membrane may be manufactured by known methods while controlling the pore size, the pore structure, and the like.

The membrane with fouling resistance may be a separation membrane for water treatment, wherein the inner layer is a microfiltration membrane, an ultrafiltration membrane, a nanofiltration membrane, a reverse osmotic membrane, or a forward osmotic membrane. Further, for example, the inner layer may be a single membrane formed of a homogeneous material, or a composite membrane including a plurality of layers formed of a heterogeneous material.

In the case that the membrane with fouling resistance is a separation membrane for water treatment, the inner membrane may include pores, and the organic/inorganic composite compound for fouling resistance may penetrate into the pores exposed on the surface of the inner membrane when coating a surface layer.

In the case that the membrane with fouling resistance is a separation membrane for water treatment, it may be used for various water treatment devices, (e.g., a water treatment device of a reverse osmosis type, a water treatment device of a forward osmosis type, and the like), but is not limited thereto.

The water treatment device may be applied to water purification, wastewater treatment and reuse, seawater desalination, oil separation, food processing, and the like.

Hereinafter, the embodiments are illustrated in more detail with reference to examples. However, the following are example embodiments and are not limiting.

### MODE FOR INVENTION

### Examples

### Precursor Synthesis

### 1) Synthesis of octakis(3-hydroxypropyldimethylsiloxy)octasilsesquioxane (OHPS)

About 0.5 g of octakis(hydrodimethylsiloxy)octasilsesquioxane (commercially available reagent, see the following Chemical Formula 13) is put in a 50 ml round-bottomed flask and dissolved in about 6 ml of toluene, and then about 0.34 ml of allyl alcohol is added thereto. Then, platinum(0)-1,3-divinyl-1,1,3,3-tetramethyldisiloxane (a 2 wt % Pt/xylene solution) is injected using a syringe, while agitating the reaction solution at about 25° C. under a nitrogen atmosphere. After reacting for 1 hour, toluene and unreacted allyl alcohol are removed with a rotary evaporator. The obtained material is dried in a vacuum oven at about 35° C. for an additional 12 hours to obtain about 0.748 g of brown solid OHPS (see the following Chemical Formula 14).

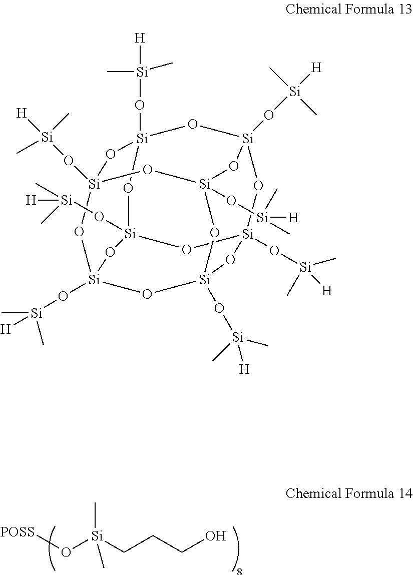

The above Chemical Formula 14 represents a form where 8 H atoms are substituted by —(CH₂)₃—OH groups in Chemical Formula 13, wherein POSS is an abbreviation of polyhedral oligomeric silsesquioxane.

### 2) Synthesis of octakis(bromodimethylesterpropyldimethylsiloxy)octasilsesquioxane (OBPS)

About 0.745 g of OHPS is put in a 100 ml round-bottomed flask and dissolved in about 15 ml of dichloromethane, and then cooled to about 0° C. using ice water. Then, about 1.14 ml of triethylamine is injected and sufficiently agitated. Subsequently, about 1.014 ml of 2-bromoisobutyryl bromide is dripped therein. After the injection is completed, the reaction solution is agitated at room temperature for about 12 hours. The product is dissolved in about 100 ml of dichloromethane, and then moved to a 500 ml separatory funnel and extracted twice with about 100 ml of distilled water to remove salts produced as a by-product. Water is removed from the dichloromethane layer using MgSO₄, and then a solid phase is filtered and the solvent is removed with a rotary evaporator. The obtained material is purified by column chromatography (mobile phase EA:Hexane=1:3 (volume ratio) to obtain a final product of about 1.06 g of OBPS (see the following Chemical Formula 15).

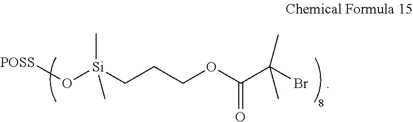

In the above Chemical Formula 15, POSS is the same as defined in Chemical Formula 13.

### Synthesis of Star-Shaped Organic/Inorganic Composite Compounds for Fouling Resistance Using OBPS

### Example 1

### Synthesis of SPC13

Using OBPS as 8-armed initiator, an organic/inorganic composite compound for fouling resistance (referred to as “SPC#,” where “#” indicates the relative mole ratio of HCMA (hydroxycardanylmethacrylate)) is synthesized according to the atom transfer radical polymerization. First, about 0.076 g of OBPS and about 6.3 g of polyethylene glycol monomethylethermethacrylate (Mn-475, PEGMA), about 0.7 g of hydroxycardanyl methacrylate (HCMA), and about 14.2 ml of anisole are introduced into a 100 ml Schlenk flask and agitated. A FPH (freeze-pump-thaw) process is repeated three times to remove oxygen in the reaction solution. Then about 16.6 mg of Cu(I)Br is added while injecting nitrogen, and the FPH process is repeated two times. The reaction flask is displaced in an oil bath at 65° C. and injected with about 24.0 μl of N,N,N′,N′,N″-pentamethyldiethylenetriamine (PMDETA) to initiate the reaction. After agitating for 12 hours, the product is dissolved in about 50 ml of dichloromethane and passed through a column filled with aluminum oxide twice to remove a catalyst. The obtained solution is precipitated in about 400 ml of hexane three times to provide an organic/inorganic SPC composite compound for fouling resistance represented by the following Chemical Formula 16. The obtained organic/inorganic SPC composite compound for fouling resistance (SPC13) has a number average molecular weight of about 105,900.

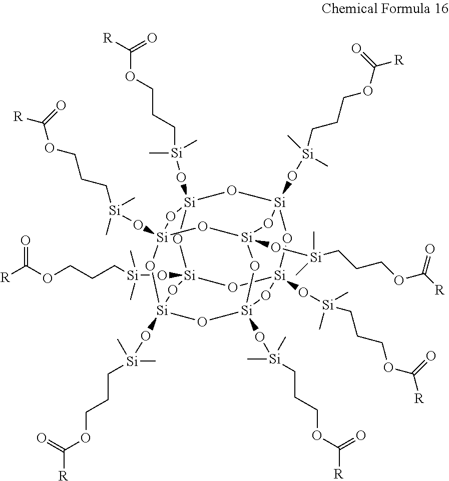

In Chemical Formula 16, R is represented by the following Chemical Formula 17:

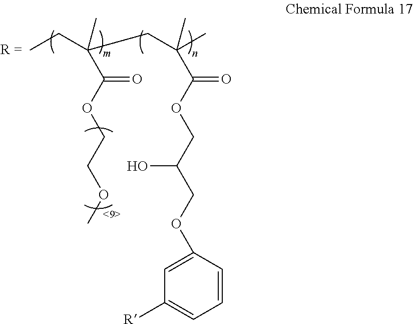

In the above Chemical Formula 17, R′ is a saturated or unsaturated carbohydrate group represented as below, each of which is present at the ratio as below. In the above Chemical Formula 17, m and n indicate polymerization degree of each unit.

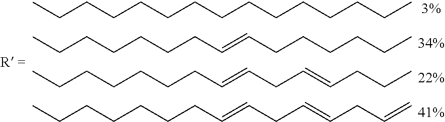

The ratio of m to n, i.e., m:n, of the obtained SPC compound is about 87:13. For example, the ratio of m to n may be determined by analyzing graphs obtained by X-ray Photoelectron Spectroscopy (XPS) (Please refer to FIG. 3 attached to this application). The content of HCMA (hydroxycardanyl methacrylate) (mol % of n) of the obtained compound is 13, and thus the compound is named as SPC13.

### Example 2

### Synthesis of SPC24

An organic/inorganic composite compound for fouling resistance (SPC24) represented by the above Chemical Formula 16 is prepared in accordance to substantially the same procedure as in Example 1, except that about 5.6 g of PEGMA, about 1.4 g of HCMA, about 8.5 ml of anisole, about 0.04 g of OBPS, about 10.0 mg of CuBr, and about 14.4 μl of PMDETA are used, wherein the obtained SPC24 compound has a number average molecular weight of about 203,100.

The ratio of m:n of the compound SPC24 is also determined by analyzing the graph of XPS shown in FIG. 3, and it is about 76:24. The content of HCMA (hydroxycardanyl methacrylate) (mol % of n) of the obtained compound is 24, and thus the compound is named as SPC24.

### Comparative Example 1

### Synthesis of SPC0

An organic/inorganic composite compound for fouling resistance (SPC0) represented by the above Chemical Formula 16 is prepared in accordance to substantially the same procedure as in Example 1, except that about 7.2 g of PEGMA, about 0 g of MMA, about 8.53 ml of anisole, about 0.046 g of OBPS, about 10.0 mg of CuBr, and about 14.4 of PMDETA are used, wherein the obtained SPC0 compound has a number average molecular weight of about 153,100. Since the obtained compound includes only the side chains with hydrophilic polyethylene glycol, the compound is named as SPC0.

### Comparative Example 2

### Synthesis of SPC45

An organic/inorganic composite compound for fouling resistance (SPC45) represented by the above Chemical Formula 16 is prepared in accordance to substantially the same procedure as in Example 1, except that about 4.2 g of PEGMA, about 2.8 g of HCMA, about 16.1 ml of Anisole, about 0.086 g of OBPS, about 18.8 mg of CuBr, and about 27.1 μl of PMDETA are used, wherein the obtained SPC compound has a number average molecular weight of about 153,100.

The ratio of m:n of the compound SPC24 is also determined by analyzing the graph of XPS shown in FIG. 3, and it is about 55:45. The content of HCMA (hydroxycardanyl methacrylate) (mol % of n) of the obtained compound is 45, and thus the compound is named as SPC45.

### Comparative Example 3

### Synthesis of SPC69

An organic/inorganic composite compound for fouling resistance (SPC69) represented by the above Chemical Formula 16 is prepared in accordance to substantially the same procedure as in Example 1, except that about 2.8 g of PEGMA, about 4.2 g of HCMA, about 18.9 ml of Anisole, about 0.10 g of OBPS, about 22.2 mg of CuBr, and about 32.0 μl of PMDETA are used, wherein the obtained SPC compound has a number average molecular weight of about 216,700.

The ratio of m:n of the compound is about 31:69, and thus the compound is named as SPC69.

### Evaluation of Solubility Characteristics

### Experimental Example 1

Solubility in water of each compound synthesized in Examples 1, and 2, and Comparative Examples 1 to 3 is evaluated, and the results are described in the following Table 1. To evaluate solubility, about 10 mg of each compound synthesized in Examples 1 and 2, and Comparative Examples 1 to 3 is impregnated with about 2 g of water and methanol at room temperature for about 24 hours, and allowed to stand. Then, a visual inspection was performed. If the aqueous solution of the compound was a transparent liquid, then the compound was soluble. If precipitation was observed in the aqueous solution of the compound, then the compound was insoluble. Further, in order to evaluate solubility of each compound after curing, about 10 mg of each compound radiated by UV is impregnated with about 2 g of water, and allowed to stand. Then, a visual inspection was performed. If the aqueous solution of the compound was a transparent liquid, then the compound was soluble. If precipitation was observed in the aqueous solution of the compound, then the compound was insoluble.

TABLE 1

| | Water | Methanol |
|---|---|---|
| | solubility | solubility |
| Example 1(SPC13)-before curing | soluble | soluble |
| Example 1(SPC13)-after curing | insoluble | — |
| Example 2(SPC24)-before curing | soluble | soluble |
| Example 2(SPC24)-after curing | insoluble | — |
| Comparative Example 1(SPC0)-before curing | soluble | soluble |
| Comparative Example 1(SPC0)-after curing | soluble | — |
| Comparative Example 2(SPC45-before curing | soluble | soluble |
| Comparative Example 2(SPC45)-after curing | insoluble | — |
| Comparative Example 3(SPC69)-before curing | insoluble | insoluble |
| Comparative Example 3(SPC69)-after curing | insoluble | — |

### Preparative Example 1

### Fabrication of a Membrane with Fouling Resistance

Each compound prepared in Example 1 (SPC13), Example 2 (SPC24), and Comparative Example 2 (SPC45) is dissolved in methanol to provide a solution. Then, the solution is coated on the surface of a commercially available polysulfone membrane by spin coating to provide a surface layer. The spin coating conditions are set as 1 wt % of sample concentration, 2000 rpm, and 60 seconds. Thereby, a membrane including the surface layer and the inner layer (polysulfone) is obtained. SPC69 compound prepared in Comparative Example 3 was not able to be manufactured to a membrane, since the compound hardly dissolves in methanol. Membranes coated with the compounds prepared in accordance with Example 1, Example 2, Comparative Example 1, and Comparative Example 2 are soluble in water before curing, and thus are not expected to be used for a long time. In order to reduce solubility in water, methanol solution was coated on the surface, and was cured by UV radiation to cure the polymer sample. Membranes coated with the compounds according to Example 1, Example 2, and Comparative Example 2 after curing are not soluble in water. Membrane coated with the compound according to Comparative Example 1, however, is still soluble in water after curing, and thus it is not expected to be used as a long term membrane for fouling resistance. Accordingly, it is acknowledged that PEGMA and HCMA should be present in appropriate range of ratio therebetween.

Evaluation of Surface Morphology of Membrane with Fouling Resistance

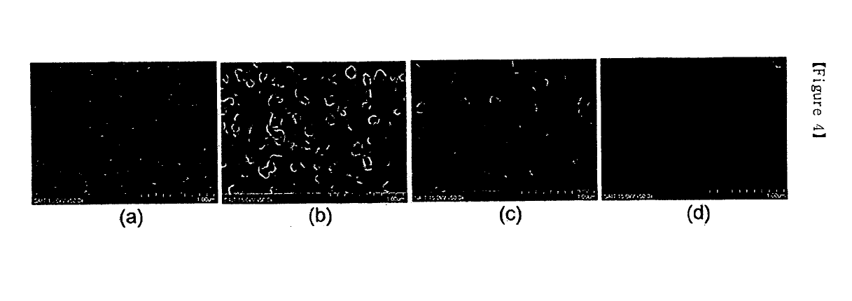

In order to observe the change in the surface morphology of before and after forming a surface layer of a membrane with fouling resistance, the compound SPC13 according to Example 1, the compound SPC24 according to Example 2, and the compound SPC45 according to Comparative Example 2 are respectively coated on a polysulfone membrane surface to provide a membrane with fouling resistance, and the surface of the membrane with fouling resistance is observed by a scanning electron microscope (SEM) and is shown in FIG. 4.

FIG. 4 (a) magnifies the morphology structure of commercially available ultrafiltration polysulfone layer by 50,000 times; and FIGS. 4 (b), 4 (c), and 4 (d) are scanning electron microscope photographs magnifying the cross-section of the membrane with fouling resistance obtained by coating SPC13 according to Example 1, SPC24 according to Example 2, and SPC45 according to Comparative Example 2 on the commercially available ultrafiltration polysulfone layer of FIG. 4 (a) by 50,000 times. As shown in FIG. 4, it is confirmed that the pore size of the membranes manufactured using SPC13, SPC24, and SPC45 are reduced compared to the size of the commercialized ultrafiltration polysulfone membrane. Specifically, the pore size of the membrane prepared from SPC45 has been significantly reduced compared to the polysulfone membrane, and thus the membrane does not have the shape of an ultrafiltration membrane.

### Measurement of Wettability of the Surface of the Membrane for Fouling Resistance

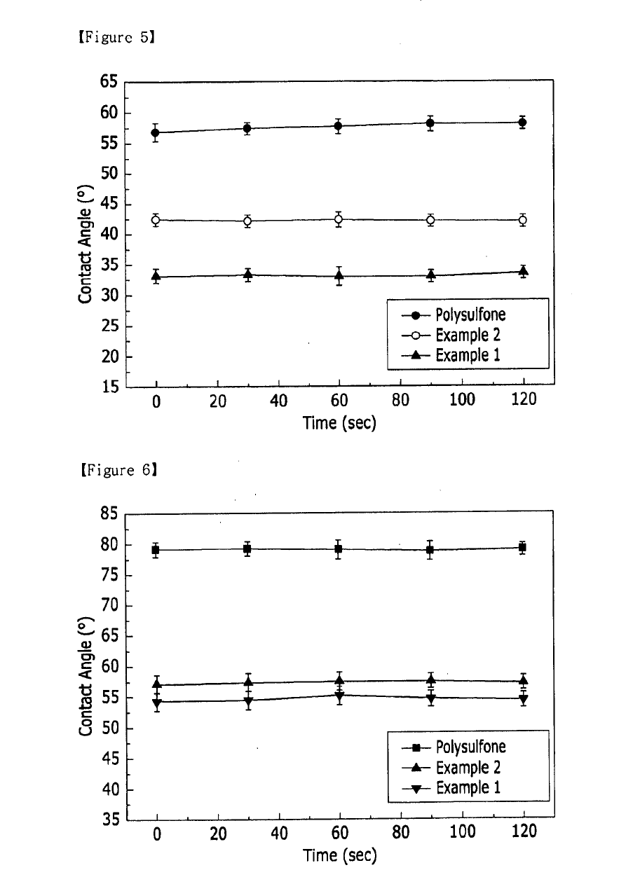

The membranes obtained by using the ultrafiltration polysulfone layer and SPC13 of Example 1, and SPC24 of Example 2 are measured for contact angle, and the results are shown in FIG. 5. As shown from FIG. 5, the membrane coated with 1 wt % of SPC13 (Example 1) in methanol solution has the smallest contact angle to water, thus is the most hydrophilic. Then, the membrane coated with 1 wt % of SPC24 (Example 2) in methanol solution follows. These two membranes do not change in contact angles over time. On the contrary, the commercialized polysulfone ultrafiltration membrane without coating has the largest contact angle to water, and further, the contact angle of the membrane gradually increases over time.

The contact angle to decane has also been determined for the membranes, and the results are shown in FIG. 6. As shown from FIG. 6, the membrane coated with 1 wt % of SPC13 (Example 1) in methanol solution has the smallest contact angle to decane, and then the membrane coated with 1 wt % of SPC24 (Example 2) in methanol solution follows. These two membranes do not change in contact angles over time. On the contrary, the commercialized polysulfone ultrafiltration membrane without coating has the largest contact angle to decane, and further, the contact angle of the membrane gradually increases over time.

### Measurement of Pure Water Permeation Rate

To determine performance of the ultrafiltration membranes prepared above, the pure water permeation rate is measured and the results are described in the following Table 2. First, each membrane is located on a cell having an effective area of about 41.8 cm² for measurement and then compacted under pressure of about 2 Kg/cm² for about 2 hours, and is measured under pressure of about 1 Kg/cm². The permeation rate is calculated by the following equation:

F=V/(A×t)

In the above equation, V denotes the permeation rate, A denotes the area of the membrane, and t denotes the operation time.

TABLE 2

| | | PURE WATER |
|---|---|---|
| | COAT | PERMEATION |
| | CONDITIONS | RATE (LMH) |
| ULTRAFILTRATION MEMBRANE | — | 440 |
| (POLYSULFONE) | | |
| ULTRAFILTRATION MEMBRANE | 1 wt %, | 370 |
| COATED WITH SPC13 | 2000 rpm, 60 s | |
| (EXAMPLE 1) AFTER CURING | | |
| ULTRAFILTRATION MEMBRANE | 1 wt %, | 320 |
| COATED WITH SPC24 | 2000 rpm, 60 s | |
| (EXAMPLE 2) AFTER CURING | | |
| ULTRAFILTRATION MEMBRANE | 1 wt %, | — |
| COATED SPC45 | 2000 rpm, 60 s | |
| (COMPARATIVE EXAMPLE 2) | | |
| AFTER CURING | | |

The LMH denotes the amount of passing water per unit hour, the L denotes the amount of water passing through the membrane (liter), the M denotes the area of the membrane (m²), and the H denotes passing time (hours). That is, it is an evaluation unit for how many liters of water pass through the membrane area of about.1 m² in about 1 hour. As shown in Table 2, it is confirmed that the pure water permeation rates for the membrane coated with the compound according to Example 1 and with the compound according to Example 2 are reduced by about 16.0%, and about 27.0%, respectively, compared to the polysulfone ultrafiltration membrane before the coating, and the water permeability is a little deteriorated by coating.

### Measurement of Fouling Resistance (Anti-Bio-Fouling Characteristic)

A permeation rate is measured to determine the fouling resistance performance of the membrane with fouling resistance obtained by using the organic/inorganic composite compound for fouling resistance (SPC13) according to Example 1, after curing, the organic/inorganic composite compound for fouling resistance (SPC24) according to Example 2, after curing, and the compound SPC13 according to Example 1, but before curing.

First, the membrane with fouling resistance is displaced on a measurement cell having an effective area of about 41.8 cm² and measured in a pressure flowing speed of 1 Kg/cm² for 3 hours.

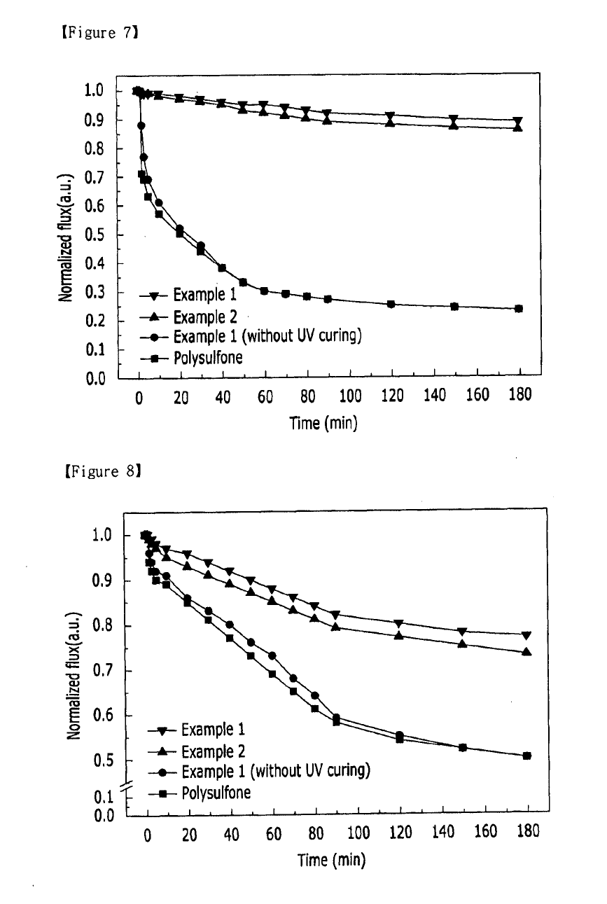

FIG. 7 is a graph showing the change in permeation rate according to the time lapse, and the maintenance ratio of permeation rate after 3 hours is calculated and shown in the following Table 3.

The fouling test material is bovine serum albumin (BSA) protein having a concentration of about 1.0 mg/mL in about 0.1M phosphate buffered saline (PBS) solution.

TABLE 3

| | RATE OF MAINTENANCE OF |
|---|---|
| | PERMEATION RATE (%) |
| ULTRAFILTRATION MEMBRANE | 23 |
| (POLYSULFONE) | |
| MEMBRANE COATED WITH SPC13 | 89 |
| (EXAMPLE 1) AFTER CURING | |
| MEMBRANE COATED WITH SPC24 | 86 |
| (EXAMPLE 2) AFTER CURING | |
| MEMBRANE COATED WITH SPC13 | 23 |
| (EXAMPLE 1) BEFORE CURING | |

As shown in Table 3, the maintenance ratio of permeation rate is maintained at about 23%, about 89%, about 86%, and about 23%, respectively, before coating the ultrafiltration membrane, or when coated with SPC13 (Example 1-after curing), SPC24 (Example 2-after curing), and SPC13 (Example 1-before curing). SPC13 (Example 1-after curing) has the largest resistance to the bio-fouling, and SPC13 (Example 1-before curing) and the uncoated ultrafiltration PS membrane have similar resistance to the bio-fouling.

### Measurement Test 2 of Fouling Resistance (Anti-Oil-Fouling Characteristics)

The permeation rate is measured to determine the fouling resistance performance of membranes with fouling resistance obtained by using the organic/inorganic composite compound (SPC13) according to Example 1, the organic/inorganic composite compound (SPC24) according to Example 2, and the compound (SPC13) according to Example 1, but before curing. First, each membrane with fouling resistance is displace on a measurement cell having an effective area of about 41.8 cm² and measured in a pressure flowing speed of about 1 Kg/cm² for 3 hours. FIG. 8 is a graph showing the change in permeation rate according to the time lapse, and the maintenance ratio of permeation rate after three hours is calculated and is shown in the following Table 4. The fouling test material is a vacuum pump oil having a concentration of about 0.9 mg/mL in a distilled water solution, and the surfactant is sodium dodecyl sulfate (SDS) having a concentration of about 0.1 mg/mL.

TABLE 4

| | RATE OF MAINTENANCE OF |
|---|---|
| | PERMEATION RATE (%) |
| ULTRAFILTRATION MEMBRANE | 50 |
| (POLYSULFONE) | |
| MEMBRANE COATED WITH SPC13 | 77 |
| (EXAMPLE 1) AFTER CURING | |
| MEMBRANE COATED WITH SPC24 | 73 |
| (EXAMPLE 2) AFTER CURING | |
| MEMBRANE COATED WITH SPC13 | 50 |
| (EXAMPLE 1) BEFORE CURING | |

As shown in Table 4, the maintenance ratio of the permeation rate is maintained at about 50%, about 77%, about 73%, and about 50%, respectively, before coating the ultrafiltration membrane or when coating with the SPC13 (Example 1-after curing), SPC24 (Example 2-after curing), and SPC13 (Example 1-before curing) solutions. SPC13 (Example 1-after curing) and SPC24 (Example 2-after curing) has superior resistance to oil fouling. SPC13 (Example 1-before curing) and the uncoated ultrafiltration PS membrane have similar resistance to the oil-fouling.

### Measurement of Anti-Microbial Effects

E. coli (bacteria) was inoculated on films manufactured according to Preparative Example 1 by using SPC0 (Comparative Example 1), SPC13 (Example 1), SPC24 (Example 2), and SPC45 (Comparative Example 2). Then, each film inoculated with bacteria was covered with OHP (overhead project) film, and cultured for 24 hours in an incubator of 37° C. After incubation, bacteria maintained on the film and on the OHP film was washed with PBS (phosphate buffered saline, pH 7.2), and the solution is inoculated and spreaded on nutrient agar plate, respectively.

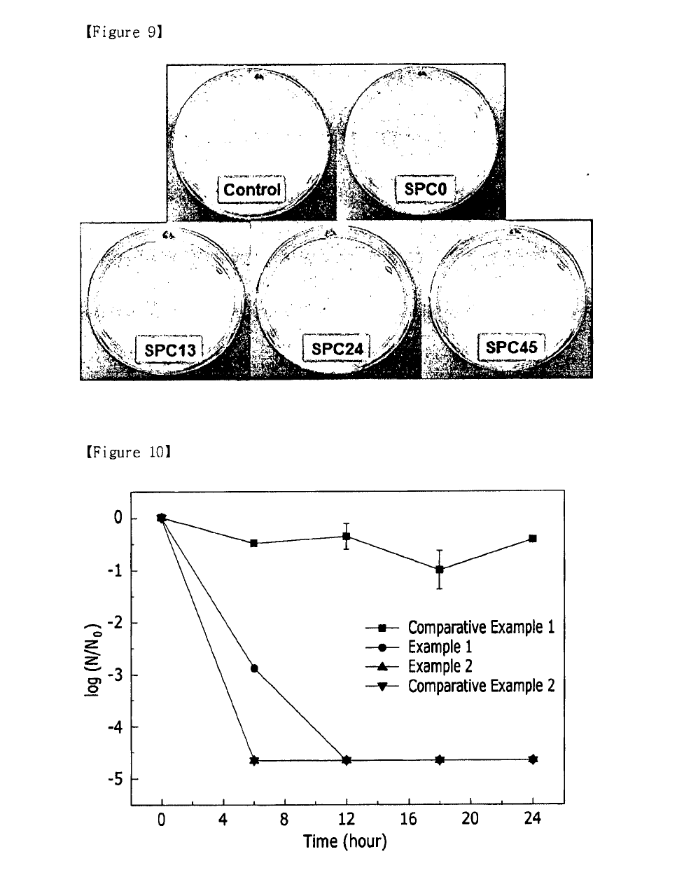

FIG. 9 shows the inoculated agar plates after incubation for 24 hours in an incubator of 37° C. Silicon wafer without coating was used as a control. That is, bacteria was inoculated on a silicon wafer without coating, OHP film was covered thereon, and then was cultured for 24 hours in an incubator of 37° C. After the incubation, bacteria maintained on the silicon wafer and on the OHP film was washed with PBS (phosphate buffered saline, pH 7.2), and the solution was inoculated on a nutrient agar plate. Then, the plate was maintained for 24 hour in an incubator of 37° C., and was indicated as ‘control’ in FIG. 9.

As shown in FIG. 9, bacteria can hardly survive after being incubated on the films including the compounds according to the Examples. Further, the higher the content of HCMA (hydroxycardanyl methacrylate), the higher the anti-biotic effect is. However, if the concentration of HCMA is equal to or greater than 24%, bacteria cannot survive, and thus there is no need to include more HCMA than required.

Further, FIG. 10 shows the number of bacteria colonies upon time lapse. In order to obtain the results, bacteria was obtained by using ultrafiltration of 1,000 g, 10 minutes, and washed with PBS. The washed bacteria was inoculated in liquid media including at the same concentrations of the compounds according to Example 1, Example 2, Comparative Example 1, and Comparative Example 2, respectively, at the early bacterial concentration of 1×10⁶ CFU (colony forming unit)/mL, and were incubated for 24 hours in an incubator of 37° C. Each 0.1 mL sample of the culture was extracted at every unit time, and then diluted to 1/10 or 1/100 to spread on a nutrient agar plate. Then the number of bacteria was determined by the spread plate method. That is, after spreading the 1/10 or 1/100 diluted sample or undiluted sample on each plate, the number of bacteria colony was determined by selecting sample. The results are shown in FIG. 10.

As shown from FIG. 10, in the presence of compound SPC13 according to Example 1, and compound SPC24 according to Example 2, the number of bacterial colony drastically reduced, while in the medium that does not contain HCMA in the compound according to Comparative Example 1, the number of bacteria did not reduce upon as time passes, and even gradually increases after 24 hours. That is, while the compounds according to the present invention exhibit sterilization effect, the compound according to Comparative Example 1 does not exhibit the effect.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. An organic/inorganic composite compound, comprising:
a core of a polyhedron of a polyhedral oligomeric silsesquioxane; and
at least one arm connected to a silicon (Si) atom of the polyhedral oligomeric silsesquioxane,
wherein the at least one arm includes a vinyl-based first structural unit and a vinyl-based second structural unit,
the vinyl-based first structural unit includes at least one ethylene oxide group at a side chain thereof, and
the vinyl-based second structural unit includes at least one anti-biotic functional group at a side chain thereof.

2. The organic/inorganic composite compound of claim 1, wherein the vinyl-based first structural unit including at least one ethylene oxide group at a side chain thereof is a structural unit represented by the following Chemical Formula 7, and the vinyl-based second structural unit including an anti-biotic functional group at a side chain thereof is a structural unit represented by the following Chemical Formula 9: 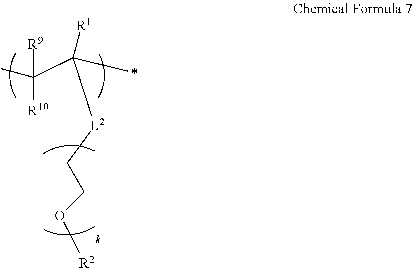
wherein in the above Chemical Formula 7,
L² is one of a single bond, —O—, —OOC—, —COO—, —OCOO—, —NHCO—, —CONH—, —CO—, —SO₂—, a substituted or unsubstituted C₁-C₃₀ alkylene group, a substituted or unsubstituted C₅ to C₃₀ arylene group, a substituted or unsubstituted C₃-C₃₀ cycloalkylene group, a substituted or unsubstituted C₁-C₃₀ heterocycloalkylene group, a substituted or unsubstituted C₁-C₃₀ heteroarylene group, a substituted or unsubstituted C₂-C₃₀ alkylarylene group, a substituted or unsubstituted C₂-C₃₀ arylalkylene group, and a group where at least one group of the foregoing groups is linked together,
each of R¹, R², R³, and R⁴ are independently one of hydrogen, a substituted or unsubstituted C₁ to C₃₀ alkyl group, a substituted or unsubstituted C₅ to C₃₀ aryl group, a substituted or unsubstituted C₃-C₃₀ cycloalkyl group, a substituted or unsubstituted C₁-C₃₀ heterocycloalkyl group, a substituted or unsubstituted C₁-C₃₀ heteroaryl group, a substituted or unsubstituted C₂-C₃₀ alkylaryl group, and a substituted or unsubstituted C₂-C₃₀ arylalkyl group, and
k is an integer ranging from 1 to 500; and 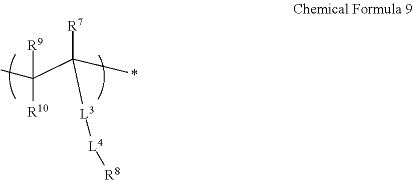
wherein in the above Chemical Formula 9,
each of R⁷, R⁹, and R¹⁰ are independently one of hydrogen, a substituted or unsubstituted C₁ to C₃₀ alkyl group, a substituted or unsubstituted C₅ to C₃₀ aryl group, a substituted or unsubstituted C₃-C₃₀ cycloalkyl group, a substituted or unsubstituted C₁-C₃₀ heterocycloalkyl group, a substituted or unsubstituted C₁-C₃₀ heteroaryl group, a substituted or unsubstituted C₂-C₃₀ alkylaryl group, and a substituted or unsubstituted C₂-C₃₀ arylalkyl group,
L³ is one of a single bond, —O—, —OOC—, —COO—, —OCOO—, —NHCO—, —CONH—, —CO—, —SO₂—, a substituted or unsubstituted C₁-C₃₀ alkylene group, a substituted or unsubstituted C₅ to C₃₀ arylene group, a substituted or unsubstituted C₃-C₃₀ cycloalkylene group, a substituted or unsubstituted C₁-C₃₀ heterocycloalkylene group, a substituted or unsubstituted C₁-C₃₀ heteroarylene group, a substituted or unsubstituted C₂-C₃₀ alkylarylene group, a substituted or unsubstituted C₂-C₃₀ arylalkylene group, and a group where at least one group of the foregoing groups is linked together,
L⁴ is one of a single bond, —O—, —OOC—, —COO—, —OCOO—, —NHCO—, —CONH—, —CO—, —SO₂—, a substituted or unsubstituted C₁-C₃₀ alkylene group, a substituted or unsubstituted C₂-C₃₀ alkenylene group, a substituted or unsubstituted C₅ to C₃₀ arylene group, a substituted or unsubstituted C₃-C₃₀ cycloalkylene group, a substituted or unsubstituted C₁-C₃₀ heterocycloalkylene group, a substituted or unsubstituted C₁-C₃₀ heteroarylene group, a substituted or unsubstituted C₂-C₃₀ alkylarylene group, a substituted or unsubstituted C₂-C₃₀ arylalkylene group, and a group where at least one group of the foregoing groups is linked together, and
R⁸ is a group represented by the following Chemical Formula 10: 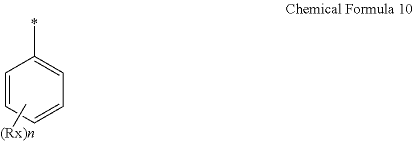
wherein in the above Chemical Formula 10,
Rx is the same or different in each repeating unit, and is one of hydrogen, a hydroxy group, a nitro group, a cyano group, ═NH, ═NR¹⁰¹, wherein R¹⁰¹ is a C₁ to C₁₀ alkyl group, —NH₂, —NH(R¹⁰²), —N(R¹⁰³)(R¹⁰⁴), wherein R¹⁰² to R¹⁰⁴ are independently a C₁ to C₁₀ alkyl group, an amidino group, a hydrazine group, a hydrazone group, a carboxyl group, a C₁ to C₃₀ alkyl group, a C₁ to C₃₀ alkylsilyl group, a C₃ to C₃₀ cycloalkyl group, a C₂ to C₃₀ heterocycloalkyl group, a C₆ to C₃₀ aryl group, a C₂ to C₃₀ heteroaryl group, a C₁ to C₃₀ alkoxy group, a C₁ to C₃₀ fluoroalkyl group, a C₅ to C₃₀ alkenyl group including at least one double bond, and a C₅ to C₃₀ alkynyl group including at least one triple bond, and
n is an integer of 1 to 5,
wherein at least about 30 mol % to about 100 mol % of Rx is one of C₅ to C₃₀ alkyl group, C₅ to C₃₀ alkenyl group including at least one double bond, and C₅ to C₃₀ alkynyl group including at least one triple bond, and
wherein at least about 5 mol % to 100 mol % of which is one of C₅ to C₃₀ alkenyl group including at least one double bond and C₅ to C₃₀ alkynyl group including at least one triple bond.

3. The organic/inorganic composite compound of claim 1, wherein an atomic ratio of the silicon (Si) to oxygen (O) in the polyhedron of the polyhedral oligomeric silsesquioxane is about 1:1 to 1:1.5.

4. The organic/inorganic composite compound of claim 1,
wherein the polyhedron of the polyhedral oligomeric silsesquioxane is one selected from a pentahedron of the following Chemical Formula 1, a hexahedron of the following Chemical Formula 2, a heptahedron of the following Chemical Formula 3, an octahedron of the following Chemical Formula 4, an enneahedron of the following Chemical Formula 5, a decahedron of the following Chemical Formula 6, and the polyhedron that includes an open polyhedron having oxygen (O) in at least one —Si—O—Si— bond substituted with substituents and disconnected in the open polyhedron: 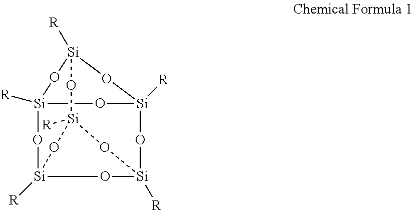 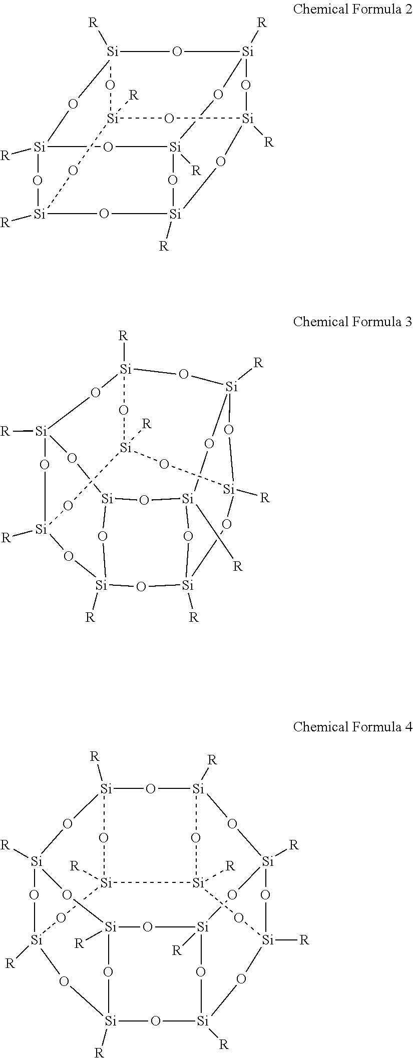 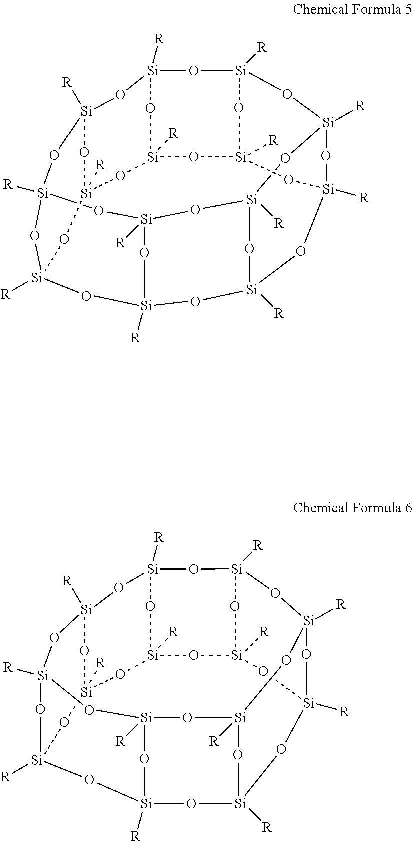
wherein in the above Chemical Formulas 1 to 6,
R is the same or different, and is independently one of hydrogen, a hydroxy group, a nitro group, a cyano group, ═NH, ═NR¹⁰¹, wherein R¹⁰¹ is a C₁ to C₁₀ alkyl group, —NH₂, —NH(R¹⁰²), —N(R¹⁰³)(R¹⁰⁴), wherein each of R¹⁰² to R¹⁰⁴ are independently C₁ to C₁₀ alkyl group, an amidino group, a hydrazine group, a hydrazone group, a carboxyl group, a C₁ to C₃₀ alkyl group, a C₁ to C₃₀ alkylsilyl group, a C₃ to C₃₀ cycloalkyl group, a C₂ to C₃₀ heterocycloalkyl group, a C₆ to C₃₀ aryl group, a C₂ to C₃₀ heteroaryl group, a C₁ to C₃₀ alkoxy group, a C₁ to C₃₀ fluoroalkyl group, and an *L¹-A group, wherein L¹ is a linking group, and A is the arm, provided that at least one group is represented by R is *-L¹-A group.

5. The organic/inorganic composite compound of claim 1, wherein the core is connected by 1 to 16 arms.

6. The organic/inorganic composite compound of claim 2, wherein the vinyl-based first structural unit including at least one ethylene oxide group at a side chain thereof is a structural unit represented by the following Chemical Formula 8: 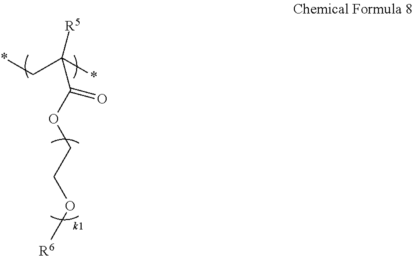
wherein in the above Chemical Formula 8,
each of R⁵ and R⁶ are independently one of hydrogen, a substituted or unsubstituted C₁ to C₃₀ alkyl group, a substituted or unsubstituted C₅ to C₃₀ aryl group, a substituted or unsubstituted C₃-C₃₀ cycloalkyl group, a substituted or unsubstituted C₁-C₃₀ heterocycloalkyl group, a substituted or unsubstituted C₁-C₃₀ heteroaryl group, a substituted or unsubstituted C₂-C₃₀ alkylaryl group, and a substituted or unsubstituted C₂-C₃₀ arylalkyl group, and
k1 is an integer of 1 to 5.

7. The organic/inorganic composite compound of claim 2, wherein the vinyl-based second structural unit including at least one anti-biotic functional group at a side chain thereof is a structural unit represented by the following Chemical Formula 11: 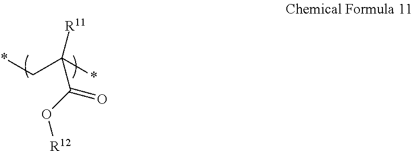
wherein in the above Chemical Formula 11,
R¹¹ is a hydrogen, a substituted or unsubstituted C₁ to C₃₀ alkyl group, a substituted or unsubstituted C₅ to C₃₀ aryl group, a substituted or unsubstituted C₃-C₃₀ cycloalkyl group, a substituted or unsubstituted C₁-C₃₀ heterocycloalkyl group, a substituted or unsubstituted C₁-C₃₀ heteroaryl group, a substituted or unsubstituted C₂-C₃₀ alkylaryl group, and a substituted or unsubstituted C₂-C₃₀ arylalkyl group, and
R¹² is a group represented by following Chemical Formula 12: 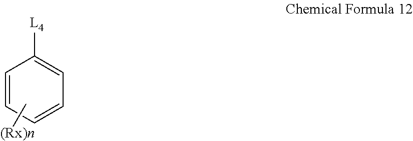
wherein in the above Chemical Formula 12,
L⁴ is one of a single bond, —O—, —NH—, —COO—, —COO—, —OCOO—, —NHCO—, —CONH—, —CO—, —SO₂—, a substituted or unsubstituted C₁-C₃₀ alkylene group, a substituted or unsubstituted C₂-C₃₀ alkenylene group, a substituted or unsubstituted C₅ to C₃₀ arylene group, a substituted or unsubstituted C₃-C₃₀ cycloalkylene group, a substituted or unsubstituted C₁-C₃₀ heterocycloalkylene group, a substituted or unsubstituted C₁-C₃₀ heteroarylene group, a substituted or unsubstituted C₂-C₃₀ alkylarylene group, a substituted or unsubstituted C₂-C₃₀ arylalkylene group, and a group where at least one group of the foregoing groups is linked together,
Rx is the same or different in each repeating unit, and is one of a hydrogen, a hydroxy group, a nitro group, a cyano group, ═NH, ═NR¹⁰¹, wherein R¹⁰¹ is a C₁ to C₁₀ alkyl group, —NH₂, —NH(R¹⁰²), —N(R¹⁰³)(R¹⁰⁴), wherein R¹⁰² to R¹⁰⁴ are independently a C₁ to C₁₀ alkyl group, an amidino group, a hydrazine group, a hydrazone group, a carboxyl group, a C₁ to C₃₀ alkyl group, a C₁ to C₃₀ alkylsilyl group, a C₃ to C₃₀ cycloalkyl group, a C₂ to C₃₀ heterocycloalkyl group, a C₆ to C₃₀ aryl group, C₂ to C₃₀ heteroaryl group, C₁ to C₃₀ alkoxy group, a C₁ to C₃₀ fluoroalkyl group, C₅ to C₃₀ alkenyl group including at least one double bond, and C₅ to C₃₀ alkynyl group including at least one triple bond, and
n is an integer ranging of 1 to 5,
wherein at least about 30 mol % to about 100 mol % of Rx is C₅ to C₃₀ alkyl group, C₅ to C₃₀ alkenyl group including at least one double bond, or C₅ to C₃₀ alkynyl group including at least one triple bond, and
wherein at least about 5 mol % to 100 mol % of which is C₅ to C₃₀ alkenyl group including at least one double bond, or C₅ to C₃₀ alkynyl group including at least one triple bond, each based on the total mole number of the repeating unit represented by Chemical Formula 11.

8. The organic/inorganic composite compound of claim 1, wherein the vinyl-based first structural unit and the vinyl-based second structural unit in the at least one arm ranges from about 95 mol %:about 5 mol % to about 60 mol %:about 40 mol %.

9. The organic/inorganic composite compound of claim 4,
wherein the L¹ is one of a single bond, —O—, —OOC—, —COO—, —OCOO—, —NX—, wherein X is one of hydrogen and a C1-C10 alkyl group), —CO—, —SO₂—, a substituted or unsubstituted C₁-C₃₀ alkylene group, a substituted or unsubstituted C₅ to C₃₀ arylene group, a substituted or unsubstituted C₃-C₃₀ cycloalkylene group, a substituted or unsubstituted C₁-C₃₀ heterocycloalkylene group, a substituted or unsubstituted C₁-C₃₀ heteroarylene group, a substituted or unsubstituted C₂-C₃₀ an alkylarylene group, a substituted or unsubstituted C₂-C₃₀ arylalkylene group, a substituted or unsubstituted silylene, a substituted or unsubstituted C₂-C₃₀ alkenyl group, a substituted or unsubstituted C₂-C₃₀ alkynyl group, and a group where at least one group of the foregoing groups is linked together.

10. A fouling resistant and anti-biotic membrane, comprising:
a surface layer including the organic/inorganic composite compound according to claim 1.

11. The fouling resistant and anti-biotic membrane of claim 10, wherein the surface layer has a contact angle of about 10 to about 90 degrees.

12. The fouling resistant and anti-biotic membrane of claim 10, wherein the surface layer has a thickness of about 0.01 μm to about 100 μm.

13. The fouling resistant and anti-biotic membrane of claim 10, further comprising:
an inner layer under the surface layer,
wherein the inner layer includes at least one of a polyacrylate-based compound, a polymethacrylate-based compound, a polystyrene-based compound, a polycarbonate-based compound, a polyethylene terephthalate-based compound, a polyimide-based compound, a polybenzimidazole-based compound, a polybenzthiazole-based compound, a polybenzoxazole-based compound, a polyepoxy resin compound, a polyolefin-based compound, a polyphenylene vinylene compound, a polyamide-based compound, a polyacrylonitrile-based compound, a polysulfone-based compound, a cellulose-based compound, polyvinylidene fluoride (PVDF), polytetrafluoroethylene (PTFE), a polyvinylchloride (PVC) compound, and a combination thereof.

14. The fouling resistant and anti-biotic membrane of claim 10, further comprising:
an inner layer under the surface layer, and
wherein the inner layer is one of a microfiltration membrane, an ultrafiltration membrane, a nanofiltration membrane, a reverse osmotic membrane, and a forward osmotic membrane.

15. The fouling resistant and anti-biotic membrane of claim 14, wherein the inner layer is a single membrane formed of one of a homogeneous material and a composite membrane including a plurality of layers formed of a heterogeneous material.

16. A method of preparing a fouling resistant and anti-biotic membrane, comprising:
preparing a solution including the organic/inorganic composite compound according to claim 1 and a solvent, and
forming a surface layer by coating the solution on a surface of a membrane subject to a fouling resistance treatment.

17. The method of claim 16, wherein the forming a surface layer by coating the solution on the surface of the membrane being performed by one of solvent casting, spin casting, wet spinning, dry spinning, melt processing, and melt spinning.

18. The method of claim 16, wherein the preparing the solution including about 0.1 to about 50 wt % of the organic/inorganic composite compound.
